(19) United States
(12) Patent Application Publication
(10) Pub. No.: US 2010/0146953 A1
(43) Pub. Date: Jun. 17, 2010

(54) EXHAUST GAS STEAM GENERATION SYSTEM

(75) Inventors: Mohinder S. Bhatti, Williamsville, NY (US); Mark J. Zima, Clarence Center, NY (US); Prasad S. Kadle, Williamsville, NY (US)

Correspondence Address: DELPHI TECHNOLOGIES, INC;LEGAL STAFF - M/C 483-400-402, 5725 DELPHI DRIVE, PO BOX 5052, TROY, MI, 48007, US

(73) Assignee: DELPHI TECHNOLOGIES, INC., Troy, MI (US)

(21) Appl. No.: 12/333,593

(22) Filed: Dec. 12, 2008

(51) Int. Cl. F01N 3/02; B60H 1/18; B23P 15/26; F01N 5/02

(52) U.S. Cl. 60/320; 237/12.3 C; 29/890.034

(57) ABSTRACT

A cylindrical stainless steel housing includes an exhaust inlet collar and exhaust outlet collar allowing exhaust gas to travel therethrough at a mean flow velocity in accordance with a velocity formula. A plurality of stainless steel tubes extend through the housing from a steam inlet manifold to a steam outlet manifold. A number and size of the tubes is determined by formulas and dependent on an Euler number, a Reynolds number, a number of transfer units, a Prandtl number, a porosity factor and a system efficiency. The tubes may comprise an S-shape or a U-shape. The tube walls have a thickness determined according to wall thickness formulas and the walls include a plurality of cavities on an interior surface of each tube wall. The cavities may comprise a conical or semi-spherical shape and have a diameter determined according to formulas.

### BACKGROUND OF THE INVENTION

1. Field of the Invention

The subject invention relates to an exhaust gas steam generation system for an automotive vehicle and the method of fabricating such a system.

2. Description of Related Art

Comfort heating systems in automotive vehicles typically include a liquid-to-air heat exchanger including a heater core located inside a heating, ventilating and air conditioning (HVAC) module, for providing heat to a passenger compartment. An engine coolant can remove approximately one third of the heat generated in an internal combustion engine, which can then be dissipated at a radiator in the front of the vehicle. During winter months, a fraction of the hot engine coolant is diverted to the heater core. Cold ambient air flowing over the heater core extracts heat from the hot engine coolant and blows it into the passenger compartment to provide heat to passengers.

In order to generate more heat for comfort heating, automotive manufacturers have developed auxiliary heaters using other sources of heat to supplement the heater core extracting heat from the engine coolant. An example of such an auxiliary heater is disclosed in U.S. Pat. No. 2,212,250 to Arthur J. Schutt. The Schutt '250 patent discloses a heater core using engine coolant as the working fluid supplemented with a “booster” heater to provide additional heat to the engine coolant when the coolant temperature is low upon initial start up. The “booster” heater includes a housing conveying exhaust gas therethrough and a plurality of U-shaped tubes conveying engine coolant therethrough, which extracts heat from the exhaust gas. When the water reaches a predetermined temperature it causes a valve to open, allowing the hot engine coolant to circulate through the heater core to provide additional heat to the engine coolant, which is used to heat the passenger compartment of the vehicle.

In recent years, internal combustion engines of automotive vehicles have become more efficient, reducing the amount of heat removed by the engine coolant and available for comfort heating. Therefore, automotive manufacturers have become more eager to use exhaust gas as an additional source of heat. In designing the exhaust gas heaters for comfort heating, certain requirements must be met. They include low pressure drop on the exhaust gas side, lest the fuel economy of the vehicle is adversely affected, and leakproofness of the heater to eliminate leakage of the toxic exhaust gas into the passenger compartment. The exhaust gas heater of the present invention meets the aforementioned essential requirements and is highly effective, compact, and durable.

### SUMMARY OF THE INVENTION

The subject invention provides an exhaust gas steam generation, which in turn provides comfort heating in a motor vehicle. Also the subject invention provides a method for fabricating the exhaust gas steam generation system. The steam generation system is located between the catalytic converter and the muffler of the vehicle exhaust system and derives thermal energy from the exhaust gas flowing therethrough to generate steam. A small amount of liquid water is placed in the pipes of the steam generation system. The dry steam generated through the evaporation of the liquid water by exhaust gas in the steam generation system is directed to the heater core of the comfort heating system located in the HVAC module of the vehicle. The air flowing over the heater core extracts thermal energy from the dry steam condensing it partially to produce wet steam, which returns to the steam generation system to continue the cycle. The latent heat of condensation of dry steam in the heater core elevates the temperature of the air, which flows into the passenger compartment providing comfort.

The steam generation system comprises a housing for conveying exhaust gas therethrough. The exhaust gas is conveyed at a mean flow velocity (vₑ), which is determined in accordance with a velocity formula

$${v}_{e} = \frac{4 {\dot{m}}_{e}}{π {ρ}_{e} D}$$

wherein D is a predetermined diameter of the housing, \dot{m}ₑ is a predetermined mass flow rate of the exhaust gas and ρₑ is a predetermined density of the exhaust gas. A plurality of tubes extend through the housing for conveying the steam therethrough. A number of the tubes is determined in accordance with a number formula

$$n = \frac{22.1 φ}{{Eu}_{e}^{5 / 8}}$$

wherein

$${Eu}_{e} = \frac{Δ {p}_{e}}{{ρ}_{e} {v}_{e}^{2} / 2 {g}_{c}} ,$$

Δpₑ is a predetermined allowable pressure drop of the exhaust gas upon encountering the tubes, g_{c} is a predetermined gravitational constant and φ is a predetermined porosity factor of the housing. Each of the tubes is defined by a tube wall having an outside diameter (dₒ) in accordance with an outside diameter formula dₒ=0.2129DEuₑ^{5/6}. The tube walls also have a projected outside area (Aₒ) in accordance with an outside area formula

$${A}_{o} = \frac{5.29 {m}_{e} {c}_{{p}_{e}} {k}_{e} NTU}{{Pr}_{e}^{0.36} {Re}_{d}^{0.63} {d}_{o}}$$

wherein

$$NTU = ln ( \frac{1}{1 - ɛ} ) , {Re}_{d} = \frac{4 {m}_{e} {d}_{o}}{{πμ}_{e} {D}^{2}} , ɛ = \frac{\dot{q}}{{\dot{m}}_{e} {c}_{pe} ( {T}_{e} - {T}_{s} )} ,$$

cₚₑ is a predetermined isobaric specific heat of the exhaust gas, \dot{q} is a predetermined rate of total heat transfer of the system, kₑ is a predetermined thermal conductivity of the exhaust gas, Prₑ is a predetermined Prandtl number of the exhaust gas, Tₑ is a predetermined temperature of the exhaust gas, μₑ is a predetermined dynamic viscosity of the exhaust gas and Tₛ is a predetermined temperature of the steam. Each of the tubes have a length (l) dependent on the projected outside area (Aₒ) of the tubes and in accordance with a length formula

$$l = \frac{{A}_{o}}{π {nd}_{o}} .$$

The specific dimensions of the housing and tubes, determined according to the method of the subject invention, yield a compact and high performance heater with lower pressure drop and higher heat transfer coefficient than existing exhaust gas heating systems. Some existing exhaust gas heating systems use engine coolant as the fluid to convey heat from the exhaust gas heater to the heater core. The engine coolant is easily degraded at the high temperature of the exhaust gas due to coagulation of the additives in the engine coolant resembling egg-white. By using water as the working fluid of the exhaust gas heater, rather than engine coolant, the problem of engine coolant degradation is avoided. Moreover, the high latent heat of evaporation of water (970 Btu/lb of water) reduces the amount of water required (about 4 ounces) thereby rendering the heating system compact. The reduced amount of water gives rise to superheated steam, which makes the system more efficient. The system can also include cavities in the tube walls, which are optimally sized according to the method of the subject invention to promote intense nucleate boiling and further increase the temperature of the steam in the tubes. In addition, the system is designed to prevent the exhaust gas from entering the passenger compartment, making the system safe for passengers riding in the automotive vehicle.

The specific dimensions of the housing and tubes, determined according to the method of the subject invention, yield a lower pressure drop and higher heat transfer coefficient than existing exhaust gas heating systems. By using steam as the working fluid, rather than engine coolant, the exhaust gas steam generation system of the present invention is more efficient and cost effective. The system can also include cavities in the tube walls, which are optimally sized according to the method of the subject invention to promote intense nucleate boiling and further increase the temperature of the steam in the tubes. In addition, the system is designed to prevent the exhaust gas from entering the passenger compartment, making the system safe for passengers riding in the automotive vehicle.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective and cross sectional view of the exhaust gas steam generation system;

FIG. 2 is a cross-sectional view of an embodiment of the exhaust gas steam generation system showing the interior surface of the tube wall including the cavities defined by the conical shape;

FIG. 3 is a cross-sectional view of an embodiment of the exhaust gas steam generation system showing the interior surface of the tube wall including the cavities defined by the semi-spherical shape;

FIG. 4 is a top and cross-sectional view of an embodiment of the exhaust gas steam generation system showing the tubes comprising the S-shape and the middle section extending along and parallel to the housing axis;

FIG. 5 is a top and cross-sectional view of an embodiment of the exhaust gas steam generation system showing the tubes comprising the U-shape;

FIG. 6 is a top and cross-sectional view of an embodiment of the heat exhaust gas steam generation system showing the steam inlet being coaxial with the second axis and the tubes being straight between the manifolds;

FIG. 7 is a top and cross-sectional view of an embodiment of the heat exhaust gas steam generation system showing the tubes comprising the S-shape and the middle section extending at the acute angle relative to the housing axis;

FIG. 8 is a top and cross-sectional view of an embodiment of the heat exhaust gas steam generation system showing the steam inlet being spaced from the steam outlet and the tubes being straight between the manifolds.

### DETAILED DESCRIPTION OF THE EXEMPLARY EMBODIMENTS

Referring to the Figures, an exhaust gas steam generation system for an automotive vehicle is shown. The system receives wet steam from a passenger compartment heater and exhaust gas from an internal combustion engine of the automotive vehicle. The wet steam extracts heat from the exhaust gas changing to superheated dry steam, which is used to heat the passenger compartment.

The system includes a housing (20) receiving the exhaust gas from the internal combustion engine of the motor vehicle. The housing (20) has a predetermined diameter (D) and a housing length (lₕ). The housing (20) typically defines a cylindrical shape disposed around a housing axis (A_{H}). The exhaust gas flows through the housing (20) at a mean flow velocity (vₑ) in accordance with a velocity formula

$${v}_{e} = \frac{4 {\dot{m}}_{e}}{{πρ}_{e} D}$$

wherein D is the diameter (D) of the housing (20), \dot{m}ₑ is the mass flow rate of the exhaust gas and ρₑ is the density of the exhaust gas.

The exhaust gas enters the housing (20) through an exhaust inlet (22) and the exhaust gas is discharged from the housing (20) through an exhaust outlet (24). An exhaust inlet collar (26) and an exhaust outlet collar (28) typically extend cylindrically from the exhaust inlet (22) and the exhaust outlet (24). The exhaust inlet collar (26) can fixedly engage an inlet exhaust pipe extending from an engine block of the automotive vehicle for conveying exhaust gas to the housing (20). The exhaust outlet collar (28) can fixedly engage an outlet exhaust pipe to discharge the exhaust gas from the automotive vehicle.

The housing (20) also receives the wet steam from the passenger compartment heater through a wet steam inlet (30), which is typically disposed around a first axis (A₁) extending transversely to the housing axis (A_{H}). The housing (20) also includes a dry steam outlet (32), which is typically disposed around a second axis (A₂) extending transversely to the housing axis (A_{H}) for discharging the steam. The system can include a wet steam inlet manifold (34) extending radially from and in sealed engagement with the housing (20) at the wet steam inlet (30). The wet steam inlet manifold (34) can fixedly engage an inlet steam pipe extending from a passenger compartment heater. The system can also include a dry steam outlet manifold (36) extending radially from and in sealed engagement with the housing (20) at the dry steam outlet (32). The dry steam outlet manifold (36) can fixedly engage an outlet steam pipe extending to the passenger compartment of the motor vehicle.

The system includes a plurality of tubes (38) extending through the housing (20) from the wet steam inlet (30) to the dry steam outlet (32) for conveying the steam therebetween. The number of tubes (n) is determined by a number formula

$$n = \frac{22.1 φ}{{Eu}_{e}^{5 / 8}}$$

wherein

$${Eu}_{e} = \frac{Δ {p}_{e}}{{ρ}_{e} {v}_{e}^{2} / 2 {g}_{c}} ,$$

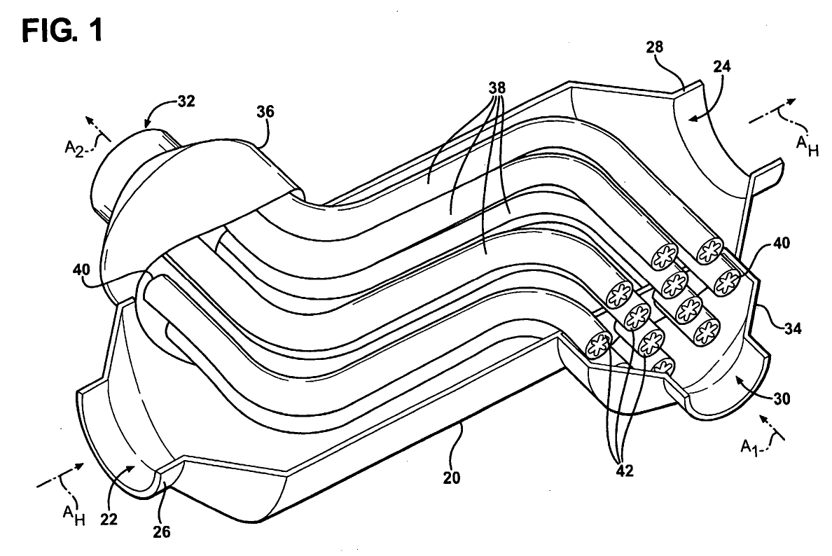

Δpₑ is a predetermined allowable pressure drop of the exhaust gas upon encountering the tubes, g_{c} is a predetermined gravitational constant and φ is a predetermined porosity factor of the housing (20). The allowable pressure drop (Δpₑ) is determined based on fuel economy considerations. In one specific embodiment, the number of tubes (38) equals twelve tubes (38), including four central tubes (38) and eight outside tubes (38) spaced about the four central tubes (38), as shown in FIG. 1. The tubes (38) extend in spaced and parallel relationship to one another along a tube axis (A_{T}) between tube ends (40), and they are typically in sealed engagement with the manifolds (34, 36).

Each of the tubes (38) are defined by a tube wall (42) having an outside diameter (dₒ) determined by an outside diameter formula dₒ=0.2129DEuₑ^{5/6}. Each of the tube walls (42) have a projected outside area (Aₒ) determined by an outside area formula

$${A}_{o} = \frac{5.29 {m}_{e} {c}_{{p}_{e}} {k}_{e} NTU}{{Pr}_{e}^{0.36} {Re}_{d}^{0.63} {d}_{o}}$$

wherein

$$NTU = ln ( \frac{1}{1 - ɛ} ) , {Re}_{d} = \frac{4 {m}_{e} {d}_{o}}{{πμ}_{e} {D}^{2}} , ɛ = \frac{\dot{q}}{{\dot{m}}_{e} {c}_{pe} ( {T}_{e} - {T}_{s} )} ,$$

cₚₑ is a predetermined isobaric specific heat of the exhaust gas, \dot{q} is a predetermined rate of total heat transfer of the system, kₑ is a predetermined thermal conductivity of the exhaust gas, Prₑ is a predetermined Prandtl number of the exhaust gas, Tₑ is a predetermined temperature of the exhaust gas, μₑ is a predetermined dynamic viscosity of the exhaust gas and Tₛ is a predetermined temperature of the steam. Each of the tubes (38) have a length ( [symbol] ) being less than the housing length (lₕ) and dependent on the projected outside area (Aₒ) and in accordance with the length formula

$$l = \frac{{A}_{o}}{π {nd}_{o}} ,$$

Each of the tube walls (42) are further defined by an interior surface (44). In the preferred embodiment, each of the interior surfaces (44) of the tube walls (42) have a plurality of cavities (46) disposed between the tube ends (40) for promoting nucleate boiling in the flow of the steam therethrough. Each of the cavities (46) have a circular periphery (48) with a cavity diameter (d_{c}) determined by a cavity diameter formula

$${d}_{c} = 7.5 \times {10}^{- 5} \sqrt{\frac{g σ}{{g}_{c} ( {ρ}_{f} - {ρ}_{g} )}} {( \frac{{ρ}_{f} {c}_{f} {T}_{s}}{{ρ}_{g} {h}_{fg}} )}^{5 / 4} ,$$

wherein g is a predetermined acceleration due to gravity, ρ_{f} is a predetermined density of the steam in a liquid phase, σ is a predetermined surface tension of the steam in the liquid phase, c_{f} is a predetermined specific heat of the steam in the liquid phase, ρ_{g} is a predetermined density of the steam in a gas phase and h_{fg} is a predetermined latent heat of condensation of the dry steam. In the preferred embodiment, the cavity diameter (d_{c}) is between 0.250 mm and 1.250 mm.

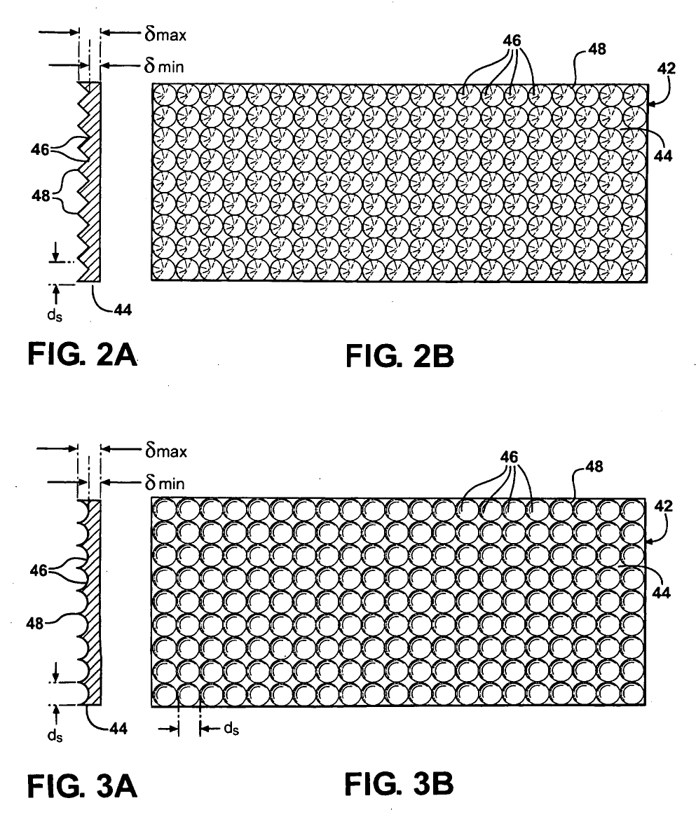

In one embodiment, the cavities (46) define a conical shape, as shown in FIG. 2. The interior surface (44) of tubes (38) including cavities (46) defined by a conical shape have an inside area (A_{ic}) determined by a conical inside area formula

$${A}_{ic} = ( 1 + \frac{π}{4} ) {A}_{o} = 1.7854 {A}_{o} .$$

In another embodiment, the cavities (46) define a semi-spherical shape, as shown in FIG. 3. The interior surface (44) of the tubes (38) including cavities (46) defined by a semi-spherical shape have an inside area (Aᵢₛ) determined by a semi-spherical inside area formula

$${A}_{is} = \{ 1 + \frac{π}{4} [ \sqrt{1 + 4 {( \frac{{δ}_{max} - {δ}_{min}}{{d}_{c}} )}^{2}} - 1 ] \} {A}_{o} .$$

Each of the tube walls (42) have a wall thickness (δ). The wall thickness (δ) is preferably greater than a minimum wall thickness (δₘᵢₙ) determined by a minimum wall thickness formula

$${δ}_{min} \geq \frac{{P}_{s} {d}_{c}}{4 {σ}_{yw}}$$

wherein σ_{yw} is a predetermined yield strength of the material of the tubes (38) and Pₛ is a predetermined vapor pressure of the steam. The wall thickness (δ) is also preferably less than a maximum wall thickness (δₘₐₓ) determined by a maximum wall thickness formula

$${δ}_{max} = {δ}_{min} + \frac{{d}_{c}}{2} .$$

In the preferred embodiment, the wall thickness (δ) is in a minimum range between 0.0250 mm and 0.125 mm and a maximum range between 0.150 mm and 0.750 mm, to achieve a high heat transfer rate and low pressure drop (Δpₑ) between the housing (20) and the tubes (38).

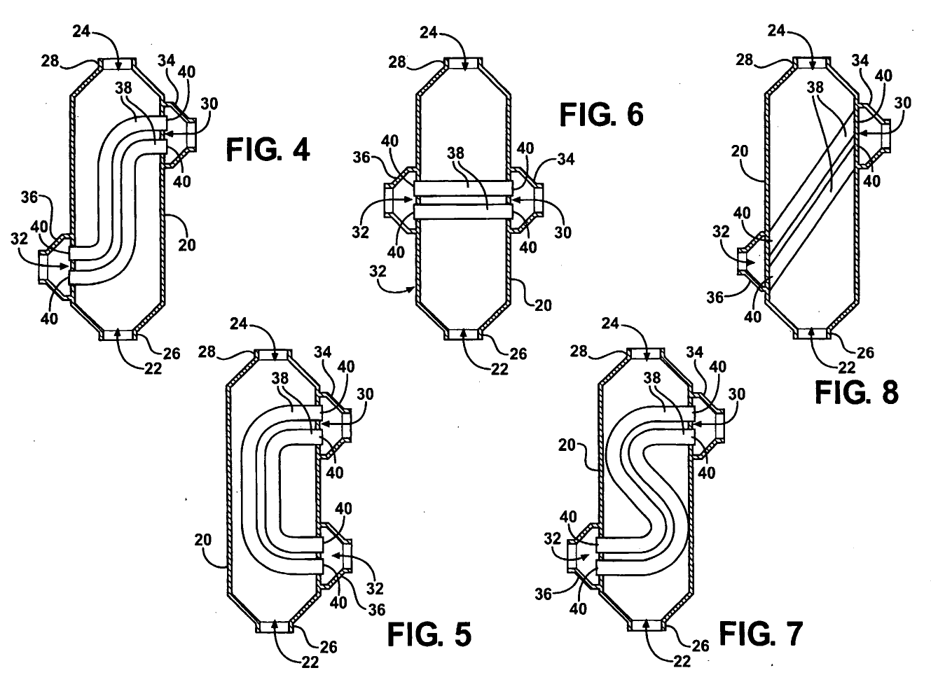

The tubes (38) can comprise one of several configurations to obtain a high heat transfer rate and low pressure drop (Δpₑ) between the housing (20) and the tubes (38). In one embodiment, the first axis (A₁) of the wet steam inlet (30) is coaxial with the second axis (A₂) of the dry steam outlet (32), as shown in FIG. 6. Typically, the second axis (A₂) of the dry steam outlet (32) is spaced along the housing axis (A_{H}) from the first axis (A₁) of the wet steam inlet (30), as shown in FIG. 4, FIG. 5, FIG. 7 and FIG. 8. The tube axis (A_{T}) can be straight between the wet steam inlet (30) and the dry steam outlet (32), as shown in FIG. 6 and FIG. 8. In the preferred embodiments, the tube axis (A_{T}) is circuitous between the wet steam inlet (30) and the dry steam outlet (32), as shown in FIG. 4, FIG. 5, and FIG. 7.

The circuitous tube axis (A_{T}), typically includes a first section extending from the wet steam inlet (30) along and parallel to the first axis (A₁) of the wet steam inlet (30), a middle section extending in the general direction of the housing axis (A_{H}) and a second section extending to the dry steam outlet (32) along and parallel to the second axis (A₂), as shown in FIG. 4, FIG. 5, and FIG. 7. The second section can extend in the same direction as the first section to define a U-shape between the wet steam inlet (30) and the dry steam outlet (32), as shown in FIG. 5. Alternatively, the second section can extend radially from the housing axis (A_{H}) in the opposite direction than the first section to define a S-shape between the wet steam inlet (30) and the dry steam outlet (32), as shown in FIG. 4 and FIG. 7. In the embodiments including tubes (38) defining an S-shape, the middle section can extend along and parallel to the housing axis (A_{H}), as shown in FIG. 4. Alternatively, the tubes (38) defining an S-shape can include a middle section extending at an acute angle relative to the housing axis (A_{H}) and in the same direction as the first section, as shown in FIG. 7.

The housing (20), manifolds (34, 36), and tubes (38) of the system typically comprise a stainless steel material. In one embodiment, the stainless steel material is 409 stainless steel, which has been extensively used in automotive exhaust systems, such as mufflers and catalytic converters, due to its excellent hot corrosion resistance. The stainless steel material can be easily rolled, forged, or extruded. A molten glass lubricant is required when the material is extruded. The melting point of the material is from about 2700° F. to about 2790° F. The composition of the stainless steel is 0.08 wt % C, 1.0 wt % Mn, 1.0 wt % Si, 10.5-11.75 wt % Cr, 0.045 wt % P, 0.045 wt % S, and a balance of Fe.

The present invention also includes a method for fabricating an exhaust gas steam generation system for an automotive vehicle. This method first includes sizing the system according to the formulas described above. A velocity of an exhaust gas through a housing (20) is determined according to a velocity formula

$${v}_{e} = \frac{4 {\dot{m}}_{e}}{{πρ}_{e} D} ,$$

as described above. Next, an Euler number (Euₑ) for the housing (20) is determined according to an Euler number formula

$${Eu}_{e} = \frac{Δ {p}_{e}}{{ρ}_{e} {v}_{e}^{2} / 2 {g}_{c}} ,$$

as described above. The Euler number is used to determine an outside diameter (dₒ) of each of a plurality of tubes (38) according to an outside diameter formula dₒ=0.2129DEuₑ^{5/6}. The method further comprises determining a number of tubes (n) extending through the housing (20) from a wet steam inlet (30) to a dry steam outlet (32) for conveying steam therebetween according to a number formula

$$n = \frac{22.1 φ}{{Eu}_{e}^{5 / 8}}$$

wherein φ is a predetermined porosity factor of the housing (20).

Next, a dimensionless Reynolds number (Re_{d}) is determined based on the outside diameter (dₒ) of the tubes (38) according to a Reynolds number formula

$${Re}_{d} = \frac{4 {m}_{e} {d}_{o}}{{πμ}_{e} {D}^{2}}$$

wherein μₑ is a predetermined dynamic viscosity of the exhaust gas. An effectiveness (ε) of the system is determined according to an effectiveness formula

$$ɛ = \frac{\dot{q}}{{\dot{m}}_{e} {c}_{pe} ( {T}_{e} - {T}_{s} )} ,$$

as described above. A thermal size of the system represented by a number of transfer units (NTU) is determined according to a number of transfer units formula

$$NTU = ln ( \frac{1}{1 - ɛ} ) .$$

The Reynolds number (Re_{d}), number of transfer units (NTU), and a predetermined Prandtl number (Prₑ) are used to determine a desired outside area (Aₒ) of each tube (38) according to an outside area formula

$${A}_{o} = \frac{5.29 {m}_{e} {c}_{{p}_{e}} {k}_{e} NTU}{{Pr}_{e}^{0.36} {Re}_{d}^{0.63} {d}_{o}} ,$$

as described above. Next, a tube length ( [symbol] ) of each tube (38) is determined according to a tube length formula

$$l = \frac{{A}_{o}}{π {nd}_{o}} .$$

In a specific embodiment, a cavity diameter (d_{c}) for each of a plurality of cavities (46) on an interior surface (44) of each tube (38) is determined according to a cavity diameter formula

$${d}_{c} = 7.5 \times {10}^{- 5} \sqrt{\frac{g σ}{{g}_{c} ( {ρ}_{f} - {ρ}_{g} )}} {( \frac{{ρ}_{f} {c}_{f} {T}_{s}}{{ρ}_{g} {h}_{fg}} )}^{5 / 4} ,$$

as described above. The cavity diameter (d_{c}) is used to determine a minimum tube wall thickness (δₘᵢₙ) and a maximum wall thickness (δₘₐₓ) of each tube (38) according to a minimum wall thickness formula

$${δ}_{min} \geq \frac{{P}_{s} {d}_{c}}{4 {σ}_{yw}}$$

and a maximum wall thickness formula

$${δ}_{max} = {δ}_{min} + \frac{{d}_{c}}{2} .$$

In a one embodiment, the cavities (46) have a conical shape and a conical inside area (A_{ic}) of the interior surface (44) of each tube (38) is determined according to a conical inside area formula

$${A}_{{i}_{c}} = ( 1 + \frac{π}{4} ) {A}_{o} = 1.7854 {A}_{o} .$$

In another embodiment, the cavities (46) have a semi-spherical shape and a semi-spherical inside area (Aᵢₛ) of the interior surface (44) of each tube (38) is determined according to a semi-spherical inside area formula

$${A}_{is} = \{ 1 + \frac{π}{4} [ \sqrt{1 + 4 {( \frac{{δ}_{max} - {δ}_{min}}{{d}_{c}} )}^{2}} - 1 ] \} {A}_{o} .$$

The method of the subject invention typically comprises physically manufacturing an exhaust gas steam generation system, sized according to the formulas described above. The method typically includes extruding a sheet of material comprising stainless steel and having a thickness greater than a minimum wall thickness (δₘᵢₙ) and less than a maximum wall thickness (δₘₐₓ). Alternatively, the sheet of material can be manufactured by other methods. Next, cavities (46) having a cavity diameter (d_{c}) and having an inside area (Aᵢ) determined according to the formulas described above can be rolled into the metal sheet. The metal sheet can then be cut into a number of elongated strips being equal to a number of tubes (n) and each having a length equal to a tube length ( [symbol] ), determined according to the formula described above. The elongated strips can have a width dependent on an outside diameter (dₒ) of the tubes (38), determined according to the outside diameter formula described above. The width of the elongated strips can be determined by a width formula w=πdₒ. The elongated strips can be formed into a plurality of tubes (38) having the outside diameter (dₒ) and tube length ( [symbol] ) determined according to the formulas described above.

The method typically includes fabricating a housing (20), which can be formed by casting or another process commonly known in the field. The housing (20) can be cast to comprise a cylindrical shape with a diameter (D) predetermined as described above, an exhaust inlet (22), an exhaust outlet (24), a wet steam inlet (30), a dry steam outlet (32), and a housing length (lₕ) greater than the tube length (l). The cast of the housing (20) may also include an exhaust inlet collar (26) and an exhaust outlet collar (28) extending radially around a housing axis (A_{H}) and extending cylindrically from the housing (20). The exhaust inlet collar (26) can be fixedly engaged to an inlet exhaust pipe extending from an engine block of the automotive vehicle. The exhaust outlet collar (28) can be fixedly engaged to an outlet exhaust pipe to discharge the exhaust gas from the automotive vehicle.

The tubes (38) are then extended through the housing (20) along a tube axis (A_{T}) from the wet steam inlet (30) to the dry steam outlet (32). The tubes (38) can be arranged in one of several configurations. The tubes (38) are typically arranged in an S-shape, as shown in FIG. 1, FIG. 4, and FIG. 7, or a U-shape, as shown in FIG. 5, extending along the tube axis (A_{T}) from the wet steam inlet (30) to the dry steam outlet (32).

Next, a wet steam inlet manifold (34) and a dry steam outlet manifold (36) can be formed by casting the stainless steel or by another process known in the field. The manifolds (34, 36) can be sealed or welded to the housing (20). The tubes (38) can be fixedly engaged to the wet steam inlet manifold (34) and dry steam outlet manifold (36) at the tube ends (40) by welding or by another method known in the field. The wet steam inlet manifold (34) can be fixedly engaged to an inlet steam pipe extending from a heater of the automotive vehicle and the dry steam outlet manifold (36) can be fixedly engaged to an outlet steam pipe extending to a passenger compartment of the automotive vehicle.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An exhaust gas steam generation system for an automotive vehicle comprising:
a housing for conveying exhaust gas therethrough at a mean flow velocity (vₑ) in accordance with a velocity formula
$${v}_{e} = \frac{4 {\dot{m}}_{e}}{{πρ}_{e} D}$$
wherein D is a predetermined diameter of said housing and \dot{m}ₑ is a predetermined mass flow rate of said exhaust gas and ρₑ is a predetermined density of said exhaust gas;
a plurality of tubes extending through said housing for conveying said steam therebetween wherein the number (n) of said tubes is determined by a number formula
$$n = \frac{22.1 φ}{{Eu}_{e}^{5 / 8}}$$
wherein
$${Eu}_{e} = \frac{Δ {p}_{e}}{{ρ}_{e} {v}_{e}^{2} / 2 {g}_{c}}$$
and Δpₑ is a predetermined allowable pressure drop of said exhaust gas upon encountering said tubes and g_{c} is a predetermined gravitational constant and φ is a predetermined porosity factor of said housing;
each of said tubes defined by a tube wall having an outside diameter (dₒ) determined by an outside diameter formula dₒ=0.2129DEuₑ^{5/6};
each of said tube walls having a projected outside area (Aₒ) determined by an outside area formula
$${A}_{o} = \frac{5.29 {m}_{e} {c}_{{p}_{e}} {k}_{e} NTU}{{Pr}_{e}^{0.36} {Re}_{d}^{0.63} {d}_{o}}$$
wherein
$$NTU = ln ( \frac{1}{1 - ɛ} ) and {Re}_{d} = \frac{4 {m}_{e} {d}_{o}}{π {μ}_{e} {D}^{2}} and ɛ = \frac{\dot{q}}{{\dot{m}}_{e} {c}_{pe} ( {T}_{e} - {T}_{s} )} and {c}_{pe} \\$$
is a predetermined isobaric specific heat of said exhaust gas and \dot{q} is a predetermined rate of total heat transfer of said system and kₑ is a predetermined thermal conductivity of said exhaust gas and Prₑ is a predetermined Prandtl number of said exhaust gas and Tₑ is a predetermined temperature of said exhaust gas and μₑ is a predetermined dynamic viscosity of said exhaust gas and Tₛ is a predetermined temperature of said steam; and
each of said tubes having a length (l) dependent on said projected outside area (Aₒ) and in accordance with a length formula
$$𝓁 = \frac{{A}_{o}}{π {nd}_{o}} .$$

2. A system as set forth in claim 1 wherein:
said tube walls have an interior surface defining a plurality of cavities for promoting nucleate boiling in the flow of said steam therethrough; and
said cavities have a cavity diameter (d_{c}) determined by a cavity diameter formula
$${d}_{c} = 7.5 \times {10}^{- 5} \sqrt{\frac{g σ}{{g}_{c} ( {ρ}_{f} - {ρ}_{g} )}} {( \frac{{ρ}_{f} {c}_{f} {T}_{s}}{{ρ}_{g} {h}_{fg}} )}^{5 / 4}$$
wherein g is a predetermined acceleration rate due to gravity and ρ_{f} is a predetermined density of said steam in a liquid phase and σ is a predetermined surface tension of said steam in said liquid phase and c_{f} is a predetermined specific heat of said steam in said liquid phase and ρ_{g} is a predetermined density of said steam in a gas phase and h_{fg} is a predetermined latent heat of condensation of dry steam.

3. A system as set forth in claim 2 wherein said cavity diameter (d_{c}) is in a range between 0.250 mm to 1.250 mm.

4. A system as set forth in claim 2 wherein:
each of said tube walls have a wall thickness (δ) being greater than a minimum wall thickness (δₘᵢₙ) determined by a minimum wall thickness formula
$${δ}_{min} \geq \frac{{P}_{s} {d}_{c}}{4 {σ}_{yw}}$$
wherein σ_{yw} is a predetermined yield strength of the material of said tubes and Pₛ is a predetermined vapor pressure of said steam.

5. A system as set forth in claim 4 wherein said minimum wall thickness (δₘᵢₙ) is in a range between 0.025 mm and 0.125 mm.

6. A system as set forth in claim 4 wherein:
said wall thickness (δ) is less than a maximum wall thickness (δₘᵢₙ) determined by a maximum wall thickness formula
$${δ}_{max} = {δ}_{min} + \frac{{d}_{c}}{2} .$$

7. A system as set forth in claim 6 wherein said maximum wall thickness (δₘₐₓ) is in a range between 0.150 mm and 0.750 mm.

8. A system as set forth in claim 2 wherein said cavities define a conical shape.

9. A system as set forth in claim 8 wherein said each of said tubes have an inside area (A_{ic}) determined by a conical inside area formula
$${A}_{ic} = ( 1 + \frac{π}{4} ) {A}_{o} = 1.7854 {A}_{o} .$$

10. A system as set forth in claim 6 wherein said cavities define a semi-spherical shape.

11. A system as set forth in claim 10 wherein each of said tubes have an inside area (Aᵢₛ) determined by a semi-spherical inside area formula
$${A}_{i s} = \{ 1 + \frac{π}{4} [ \sqrt{1 + 4 {( \frac{{δ}_{max} - {δ}_{min}}{{d}_{c}} )}^{2}} - 1 ] \} {A}_{o} .$$

12. A system as set forth in claim 1 wherein said housing is disposed around a housing axis extending between a exhaust inlet for receiving said exhaust gas and an exhaust outlet for discharging said exhaust gas.

13. A system as set forth in claim 12 wherein said housing includes an exhaust inlet collar and an exhaust outlet collar extending cylindrically in opposite directions from said exhaust inlet and said exhaust outlet.

14. A system as set forth in claim 12 wherein said housing includes a wet steam inlet disposed around a first axis for receiving said steam.

15. A system as set forth in claim 14 wherein said housing includes a dry steam outlet disposed around a second axis for discharging said steam.

16. A system as set forth in claim 15 including a wet steam inlet manifold and a dry steam outlet manifold extending radially from said housing at said wet steam inlet and said dry steam outlet and being in sealed engagement with said housing.

17. A system as set forth in claim 15 wherein said first axis of said wet steam inlet is coaxial with said second axis of said dry steam outlet.

18. A system as set forth in claim 15 wherein said second axis of said dry steam outlet is spaced along said housing axis from said first axis of said wet steam inlet.

19. A system as set forth in claim 15 wherein said tubes extend along a tube axis between said tube ends from said wet steam inlet to said dry steam outlet.

20. A system as set forth in claim 19 wherein said tube axis is straight between said wet steam inlet and said dry steam outlet.

21. A system as set forth in claim 19 wherein said tube axis is circuitous between said wet steam inlet and said dry steam outlet.

22. A system as set forth in claim 21 wherein said tube axis includes a first section extending from said wet steam inlet along and parallel to said first axis of said wet steam inlet and a middle section extending in the general direction of said housing axis and a second section extending to said dry steam outlet along and parallel to said second axis of said dry steam outlet.

23. A system as set forth in claim 22 wherein said second section extends in the same direction as said first section to define a U-shape between said wet steam inlet and said dry steam outlet.

24. A system as set forth in claim 22 wherein said second section extends radially from said housing axis in the opposite direction than said first section to define a S-shape between said wet steam inlet and said dry steam outlet.

25. A system as set forth in claim 24 wherein said middle section extends along and parallel to said housing axis.

26. A system as set forth in claim 24 wherein said middle section extends at an acute angle relative to said housing axis and in the same direction as said first section.

27. A system as set forth in claim 1 wherein said system comprises stainless steel.

28. A system as set forth in claim 1 wherein said number (n) of said tubes is twelve tubes including four central tubes and eight outside tubes spaced about said four central tubes.

29. A system as set forth in claim 1 wherein said housing comprises a cylindrical shape.

30. A system as set forth in claim 1 wherein said plurality of tubes extend in spaced and parallel relationship to one another extending from said wet steam inlet to said dry steam outlet.

31. An exhaust gas steam generator system for an automotive vehicle comprising:
a housing defining a cylindrical shape and having a housing length and disposed around a housing axis extending between an exhaust inlet and an exhaust outlet on opposite sides of said housing for conveying exhaust gas therebetween at a mean flow velocity (vₑ) in accordance with a velocity formula
$${v}_{e} = \frac{4 {\dot{m}}_{e}}{π {ρ}_{e} D}$$
wherein D is a predetermined diameter of said housing and \dot{m}ₑ is a predetermined mass flow rate of said exhaust gas and ρₑ is a predetermined density of said exhaust gas;
an exhaust inlet collar disposed around said housing axis (A_{H}) and extending cylindrically from said housing for fixedly engaging an inlet exhaust pipe extending from an engine block of said automotive vehicle to convey said exhaust gas to said system;
an exhaust outlet collar disposed around said housing axis and extending cylindrically from said housing at said exhaust outlet for fixedly engaging an outlet exhaust pipe to discharge said exhaust gas from said automotive vehicle;
said housing including a steam inlet disposed around a first axis extending transversely to said housing axis for receiving steam;
said housing including a dry steam outlet disposed around a second axis extending transversely to said housing axis for discharging said steam;
a wet steam inlet manifold extending radially from and in sealed engagement with said housing at said wet steam inlet and disposed around a first axis extending transversely to said housing axis for fixedly engaging an inlet steam pipe extending from a heater of said automotive vehicle to convey said steam to said system;
a dry steam outlet manifold extending radially from and in sealed engagement with said housing at said dry steam outlet and disposed around a second axis extending transversely to said housing axis for fixedly engaging an outlet steam pipe extending to a passenger compartment of said automotive vehicle;
a plurality of tubes extending through said housing from said wet steam inlet manifold to said dry steam outlet manifold for conveying said steam therebetween wherein the number (n) of said tubes is determined by a number formula
$$n = \frac{22.1 φ}{{Eu}_{e}^{5 / 8}}$$
wherein
$${Eu}_{e} = \frac{Δ {p}_{e}}{{ρ}_{e} {v}_{e}^{2} / 2 {g}_{c}}$$
and Δpₑ is a predetermined allowable pressure drop of said exhaust gas upon encountering said tubes and g_{c} is a predetermined gravitational constant and φ is a predetermined porosity factor of said housing;
said number (n) of said tubes being twelve tubes including four central tubes and eight outside tubes spaced about said four central tubes;
said plurality of tubes extending in spaced and parallel relationship to one another along a tube axis between tube ends in sealed engagement with said manifolds;
each of said tubes defined by a tube wall having an outside diameter (dₒ) determined by the outside diameter formula dₒ=0.2129DEuₑ^{5/6};
each of said tube walls having a projected outside area (Aₒ) determined by an outside area formula
$${A}_{o} = \frac{5.29 {m}_{e} {c}_{{p}_{e}} {k}_{e} NTU}{{Pr}_{e}^{0.36} {Re}_{d}^{0.63} {d}_{o}}$$
wherein
$$NTU = ln ( \frac{1}{1 - ɛ} ) and {Re}_{d} = \frac{4 {m}_{e} {d}_{o}}{π {μ}_{e} {D}^{2}} and ɛ = \frac{\dot{q}}{{\dot{m}}_{e} {c}_{pe} ( {T}_{e} - {T}_{s} )} and {c}_{pe}$$
is a predetermined isobaric specific heat of said exhaust gas and \dot{q} is a predetermined rate of total heat transfer of said system and kₑ is a predetermined thermal conductivity of said exhaust gas and Prₑ is a predetermined Prandtl number of said exhaust gas and Tₑ is a predetermined temperature of said exhaust gas and μₑ is a predetermined dynamic viscosity of said exhaust gas and Tₛ is a predetermined temperature of said steam;
each of said tubes having a length being less than said housing length (lₕ) and being dependent on said projected outside area (Aₒ) and in accordance with a length formula
$$l = \frac{{A}_{o}}{π {nd}_{o}} ,$$
each of said tube walls having an interior surface defining a plurality of cavities disposed between said tube ends for promoting nucleate boiling in the flow of said steam therethrough;
each of said cavities having a circular periphery with a cavity diameter determined by a cavity diameter formula
$${d}_{c} = 7.5 \times {10}^{- 5} \sqrt{\frac{g σ}{{g}_{c} ( {ρ}_{f} - {ρ}_{g} )}} {( \frac{{ρ}_{f} {c}_{f} {T}_{s}}{{ρ}_{g} {h}_{fg}} )}^{5 / 4}$$
wherein g is a predetermined acceleration due to gravity and ρ_{f} is a predetermined density of said steam in a liquid phase and σ is a predetermined surface tension of said steam in said liquid phase and c_{f} is a predetermined specific heat of said steam in said liquid phase and ρ_{g} is a predetermined density of said steam in a gas phase and h_{fg} is a predetermined latent heat of condensation of dry steam;
said cavity diameter (d_{c}) being in a range between 0.250 mm and 1.250 mm;
each of said tube walls defined by a wall thickness being greater than a minimum wall thickness (δₘᵢₙ) determined by a minimum wall thickness formula
$${δ}_{min} \geq \frac{{P}_{s} {d}_{c}}{4 {σ}_{yw}}$$
wherein σ_{yw} is a predetermined yield strength of the material of said tubes and Pₛ is a predetermined vapor pressure of said steam;
said minimum wall thickness (δₘᵢₙ) being in a range between 0.025 and 0.125 mm;
each of said tube walls further defined by said wall thickness (δ) being less than a maximum wall thickness (δₘₐₓ) determined by a maximum wall thickness formula
$${δ}_{max} = {δ}_{min} + \frac{{d}_{c}}{2} ;$$
said maximum wall thickness (δₘₐₓ) being in a range between 0.150 and 0.750 mm; and
said system comprising stainless steel.

32. A system as set forth in claim 31 wherein said first axis of said wet steam inlet is coaxial with said second axis of said dry steam outlet.

33. A system as set forth in claim 32 wherein said tube axis is straight between said wet steam inlet and said dry steam outlet.

34. A system as set forth in claim 31 wherein said second axis of said dry steam outlet is spaced along said housing axis from said first axis of said wet steam inlet.

35. A system as set forth in claim 34 wherein said tube axis is straight between said wet steam inlet and said dry steam outlet.

36. A system as set forth in claim 34 wherein said tube axis is circuitous between said wet steam inlet and said dry steam outlet.

37. A system as set forth in claim 36 wherein said tube axis includes a first section extending from said wet steam inlet along and parallel to said first axis of said wet steam inlet and a middle section extending in the general direction of said housing axis and a second section extending to said dry steam outlet along and parallel to said second axis.

38. A system as set forth in claim 37 wherein said second section extends in the same direction as said first section to define a U-shape between said wet steam inlet and said dry steam outlet.

39. A system as set forth in claim 37 wherein said second section extends radially from said housing axis in the opposite direction than said first section to define a S-shape between said wet steam inlet and said dry steam outlet.

40. A system as set forth in claim 39 wherein said middle section extends along and parallel to said housing axis.

41. A system as set forth in claim 39 wherein said middle section extends at an acute angle relative to said housing axis and in the same direction as said first section.

42. A system as set forth in claim 31 wherein said cavities define a conical shape.

43. A system as set forth in claim 42 wherein said each of said tubes have an inside area (A_{ic}) determined by a conical inside area formula
$${A}_{{i}_{c}} = ( 1 + \frac{π}{4} ) {A}_{o} = 1.7854 {A}_{o} .$$

44. A system as set forth in claim 31 wherein said cavities define a semi-spherical shape.

45. A system as set forth in claim 44 wherein each of said tubes have an inside area (Aᵢₛ) determined by a semi-spherical inside area formula
$${A}_{is} = \{ 1 + \frac{π}{4} [ \sqrt{1 + 4 {( \frac{{δ}_{max} - {δ}_{min}}{{d}_{c}} )}^{2}} - 1 ] \} {A}_{o} .$$

46. A method for fabricating an exhaust gas steam generation system for an automotive vehicle comprising a housing to convey exhaust gas therethrough and a plurality of tubes extending through the housing to convey steam therethrough comprising:
determining the velocity of the exhaust gas through the housing according to a velocity formula
$${v}_{e} = \frac{4 {\dot{m}}_{e}}{π {ρ}_{e} D}$$
wherein D is a predetermined diameter of the housing (20) and \dot{m}ₑ is a predetermined mass flow rate of the exhaust gas and ρₑ is a predetermined density of the exhaust gas;
determining the Euler number (Euₑ) for the housing according to an Euler number formula
$${Eu}_{e} = \frac{Δ {p}_{e}}{{ρ}_{e} {v}_{e}^{2} / 2 {g}_{c}}$$
wherein Δpₑ is a predetermined allowable pressure drop of the exhaust gas upon encountering the tubes and g_{c} is a predetermined gravitational constant;
determining the outside diameter (dₒ) of each of the tubes according to an outside diameter formula dₒ=0.2129DEuₑ^{5/6};
determining the number of tubes (n) extending through the housing from the wet steam inlet manifold to the dry steam outlet manifold for conveying the steam therebetween according to a number formula
$$n = \frac{22.1 φ}{{Eu}_{e}^{5 / 8}}$$
wherein φ is a predetermined porosity factor of the housing;
determining the dimensionless Reynolds number (Re_{d}) based on the outside diameter (dₒ) of the tubes according to a Reynolds number formula
$${Re}_{d} = \frac{4 {m}_{e} {d}_{o}}{π {μ}_{e} {D}^{2}}$$
wherein μₑ is a predetermined dynamic viscosity of the exhaust gas;
determining the effectiveness (ε) of the system according to an effectiveness formula
$$ɛ = \frac{\dot{q}}{{\dot{m}}_{e} {c}_{pe} ( {T}_{e} - {T}_{s} )}$$
wherein \dot{q} is a predetermined rate of total heat transfer of the system and cₚₑ is a predetermined isobaric specific heat of the exhaust gas and Tₑ is a predetermined temperature of the exhaust gas and Tₛ is a predetermined temperature of the steam;
determining the thermal size of the system represented by the number of transfer units (NTU) according to a number of transfer units formula
$$NTU = ln ( \frac{1}{1 - ɛ} ) ;$$
determining a desired outside area (Aₒ) of each tube according to an outside area formula
$${A}_{o} = \frac{5.29 {m}_{e} {c}_{{p}_{e}} {k}_{e} NTU}{{Pr}_{e}^{0.36} {Re}_{d}^{0.63} {d}_{o}}$$
wherein cₚₑ is a predetermined isobaric specific heat of the exhaust gas and kₑ is a predetermined thermal conductivity of the exhaust gas and Prₑ is a predetermined Prandtl number of the exhaust gas; and
determining the tube length ( [symbol] ) of each tube being less than the housing length (lₕ) and dependent on the desired outside area (Aₒ) and according to a tube length formula
$$l = \frac{{A}_{o}}{π {nd}_{o}} .$$

47. A method set forth in claim 46 further comprising determining a cavity diameter (d_{c}) for a plurality of cavities on an interior surface of each tube according to a cavity diameter formula
$${d}_{c} = 7.5 \times {10}^{- 5} \sqrt{\frac{g σ}{{g}_{c} ( {ρ}_{f} - {ρ}_{g} )}} {( \frac{{ρ}_{f} {c}_{f} {T}_{s}}{{ρ}_{g} {h}_{fg}} )}^{5 / 4}$$
wherein g is a predetermined acceleration due to gravity and σ is a predetermined surface tension of the steam in a liquid phase and ρ_{f} is a predetermined density of the steam in a liquid phase and c_{f} is a predetermined specific heat of the steam in the liquid phase and ρ_{g} is a predetermined density of the steam in a gas phase and h_{fg} is a predetermined latent heat of condensation of dry steam.

48. A method as set forth in claim 47 further comprising determining a minimum tube wall thickness (δₘᵢₙ) of each tube according to a minimum wall thickness formula
$${δ}_{min} \geq \frac{{P}_{s} {d}_{c}}{4 {σ}_{yw}}$$
wherein σ_{yw} is a predetermined yield strength of the tubes and Pₛ is a predetermined vapor pressure of the steam.

49. A method as set forth in claim 48 determining a maximum wall thickness (δₘₐₓ) of each tube according to a maximum wall thickness formula
$${δ}_{max} = {δ}_{min} + \frac{{d}_{c}}{2} .$$

50. A method as set forth in claim 49 further comprising extruding a sheet of material comprising stainless steel and having a thickness greater than the minimum wall thickness (δₘᵢₙ) and less than the maximum wall thickness (δₘₐₓ).

51. A method as set forth in claim 50 further comprising rolling the cavities having the cavity diameter (d_{c}) determined by the cavity diameter formula and having an inside area (Aᵢ) into the sheet of material.

52. A method as set forth in claim 50 further comprising cutting the sheet of material into a number of elongated strips being equal to the number of tubes (n) and each elongated strip having a length equal to the tube length (l) and a width dependent on the outside diameter (dₒ) of the tubes determined by a width formula w=πdₒ.

53. A method as set forth in claim 52 further comprising welding the elongated strips into the plurality of tubes having the outside diameter (dₒ) and tube length ( [symbol] ).

54. A method as set forth in claim 46 further comprising fabricating the housing defining a cylindrical shape disposed around a housing axis (A_{H}) and having the predetermined diameter and a housing length (lₕ) being greater than the tube length ( [symbol] ) and including an exhaust inlet and exhaust outlet and a wet steam inlet and a dry steam outlet.

55. A method as set forth in claim 54 wherein said fabricating the housing further comprises fabricating an exhaust inlet collar and an exhaust outlet collar extending cylindrically in opposite directions from the exhaust inlet and the exhaust outlet.

56. A method as set forth in claim 54 further comprising fabricating a wet steam inlet manifold and a dry steam outlet manifold extending radially from the housing at the wet steam inlet and the dry steam outlet and being in sealed engagement with the housing.

57. A method as set forth in claim 54 further comprising extending the tubes having tube ends through the housing from the wet steam inlet to the dry steam outlet.

58. A method as set forth in claim 57 further comprising fixedly engaging the tube ends to the manifolds.

59. A method for fabricating an exhaust gas steam generator system for an automotive vehicle comprising a housing having a housing length (lₕ) to convey exhaust gas therethrough and a plurality of tubes extending through the housing to convey steam therethrough comprising:
determining the velocity of the exhaust gas through the housing according to a velocity formula
$${v}_{e} = \frac{4 {\dot{m}}_{e}}{π {ρ}_{e} D}$$
wherein D is a predetermined diameter of the housing and \dot{m}ₑ is a predetermined mass flow rate of the exhaust gas and ρₑ is a predetermined density of the exhaust gas;
determining the Euler number (Euₑ) for the housing according to an Euler number formula
$${Eu}_{e} = \frac{Δ {p}_{e}}{{ρ}_{e} {v}_{e}^{2} / 2 {g}_{c}}$$
wherein Δpₑ is a predetermined allowable pressure drop of the exhaust gas upon encountering the tubes and g_{c} is a predetermined gravitational constant;
determining the outside diameter (dₒ) of each of the tubes according to an outside diameter formula dₒ=0.2129DEuₑ^{5/6};
determining the number of tubes (n) extending through the housing from the wet steam inlet manifold to the dry steam outlet manifold for conveying the steam therebetween according to a number formula
$$n = \frac{22.1 φ}{{Eu}_{e}^{5 / 8}}$$
wherein φ is a predetermined porosity factor of the housing;
determining the dimensionless Reynolds number (Re_{d}) based on the outside diameter (dₒ) of the tubes according to a Reynolds number formula
$${Re}_{d} = \frac{4 {m}_{e} {d}_{o}}{π {μ}_{e} {D}^{2}}$$
wherein μₑ is a predetermined dynamic viscosity of the exhaust gas;
determining the effectiveness (ε) of the system according to an effectiveness formula
$$ɛ = \frac{\dot{q}}{{\dot{m}}_{e} {c}_{pe} ( {T}_{e} - {T}_{s} )}$$
wherein \dot{q} is a predetermined rate of total heat transfer of the system and cₚₑ is a predetermined isobaric specific heat of the exhaust gas and Tₑ is a predetermined temperature of the exhaust gas and Tₛ is a predetermined temperature of the steam;
determining the thermal size of the system represented by the number of transfer units (NTU) according to a number of transfer units formula
$$NTU = ln ( \frac{1}{1 - ɛ} ) ;$$
determining a desired outside area (Aₒ) of each tube according to an outside area formula
$${A}_{o} = \frac{5.29 {m}_{e} {c}_{{p}_{e}} {k}_{e} NTU}{{Pr}_{e}^{0.36} {Re}_{d}^{0.63} {d}_{o}}$$
wherein cₚₑ is a predetermined isobaric specific heat of the exhaust gas and kₑ is a predetermined thermal conductivity of the exhaust gas and Prₑ is a predetermined Prandtl number of the exhaust gas;
determining the tube length ( [symbol] ) of each tube dependent on the desired outside area (Aₒ) and according to a tube length formula
$$l = \frac{{A}_{o}}{π {nd}_{o}} ;$$
determining a cavity diameter (d_{c}) for a plurality of cavities on an interior surface of each tube according to a cavity diameter formula
$${d}_{c} = 7.5 \times {10}^{- 5} \sqrt{\frac{g σ}{{g}_{c} ( {ρ}_{f} - {ρ}_{g} )}} {( \frac{{ρ}_{f} {c}_{f} {T}_{s}}{{ρ}_{g} {h}_{fg}} )}^{5 / 4}$$
wherein g is a predetermined acceleration due to gravity and σ is a predetermined surface tension of the steam in a liquid phase and ρ_{f} is a predetermined density of the steam in a liquid phase and c_{f} is a predetermined specific heat of the steam in the liquid phase and ρ_{g} is a predetermined density of the steam in a gas phase and h_{fg} is a predetermined latent heat of condensation of dry steam;
determining a minimum tube wall thickness (δₘᵢₙ) of each tube according to a minimum wall thickness formula
$${δ}_{min} \geq \frac{{P}_{s} {d}_{c}}{4 {σ}_{yw}}$$
wherein σ_{yw} is a predetermined yield strength of the tubes and Pₛ is a predetermined vapor pressure of the steam;
determining a maximum wall thickness (δₘₐₓ) of each tube according to a maximum wall thickness formula
$${δ}_{max} = {δ}_{min} + \frac{{d}_{c}}{2} ;$$
extruding a metal sheet comprising stainless steel and having a thickness greater than the minimum wall thickness (δₘᵢₙ) and less than the maximum wall thickness (δₘₐₓ);
rolling the cavities having the cavity diameter determined by the cavity diameter formula and having an inside area into the metal sheet;
cutting the metal sheet into a number of elongated strips being equal to the number of tubes and each elongated strip having a length equal to the tube length and a width dependent on the outside diameter of the tubes and determined by a width formula w=πdₒ;
welding the elongated strips into the plurality of tubes having the outside diameter and tube length;
fabricating the housing defining a cylindrical shape around a housing axis and having the predetermined diameter and having the housing length being greater than the tube length;
said fabricating the housing including fabricating an exhaust inlet collar extending radially around the housing axis and extending cylindrically from the housing to receive the exhaust gas;
said fabricating the housing including fabricating an exhaust outlet collar extending radially around the housing axis and extending cylindrically from the housing in opposite direction from the exhaust inlet collar to discharge the exhaust gas;
fabricating a wet steam inlet manifold extending radially around a first axis transverse to the housing axis;
fabricating a dry steam outlet manifold extending radially around a second axis transverse to the housing axis;
sealing the wet steam inlet manifold and the dry steam outlet manifold to the housing;
extending the tubes through the housing from the wet steam inlet manifold to the dry steam outlet manifold;
fixedly engaging a first tube end of each of the tubes to the wet steam inlet manifold;
fixedly engaging a second tube end of each of the tubes to the dry steam outlet manifold;
fixedly engaging the wet steam inlet manifold to an inlet steam pipe extending from a heater of the automotive vehicle to convey the steam to the system;
fixedly engaging the dry steam outlet manifold to an outlet steam pipe extending to a passenger compartment of the automotive vehicle to heat the passenger compartment;
fixedly engaging the exhaust inlet collar to an inlet exhaust pipe extending from an engine block of the automotive vehicle to convey the exhaust gas to the system; and
fixedly engaging the exhaust outlet to an outlet exhaust pipe to discharge the exhaust gas from the automotive vehicle.

60. A method as set forth in claim 59 further comprising:
determining the inside area (A_{ic}) of each of the cavities having a conical shape according to a conical inside area formula
$${A}_{ic} = ( 1 + \frac{π}{4} ) {A}_{o} = 1.7854 {A}_{o} .$$

61. A method as set forth in claim 59 further comprising:
determining the inside area (Aᵢₛ) of each of the cavities having a semi-spherical shape according to a semi-spherical inside area formula
$${A}_{is} = \{ 1 + \frac{π}{4} [ \sqrt{1 + 4 {( \frac{{δ}_{max} - {δ}_{min}}{{d}_{c}} )}^{2}} - 1 ] \} {A}_{o} .$$

62. A method as set forth in claim 59 wherein said extending the tubes through the housing further comprises disposing the tubes along a tube axis defined by a S-shape extending between the manifolds.

63. A method as set forth in claim 59 wherein said extending the tubes through the housing further comprises disposing the tubes along a tube axis defined by a U-shape extending between the manifolds.

64. A method as set forth in claim 59 wherein said extending the tubes through the housing further comprises disposing the tubes along a tube axis defined by a straight line extending between the manifolds.
